(19) United States
(12) Patent Application Publication
(10) Pub. No.: US 2026/0154983 A1
(43) Pub. Date: Jun. 4, 2026

(54) SYSTEMS AND METHODS FOR OPTICAL CHARACTER RECOGNITION

(71) Applicant: ADP, Inc., Roseland, NJ (US)

(72) Inventors: Mohit Goel, Hyderabad (IN); Aninda Biswas, Hyderabad (IN); Gaurav Singh, Hyderabad (IN); Venkata Hari Innamuri, Rajahmundry (IN); Uday Shrinivas Darp, Hyderabad (IN); Shubham Dixit, Hyderabad (IN)

(73) Assignee: ADP, Inc., Roseland, NJ (US)

(21) Appl. No.: 18/967,298

(22) Filed: Dec. 3, 2024

(51) Int. Cl. G06V 30/418; G06V 30/19; G06V 30/412

(52) U.S. Cl. CPC G06V 30/418; G06V 30/19093; G06V 30/412

(57) ABSTRACT

A system can include one or more processors to receive a compressed file, split the compressed first file into a first document and a second document, detect a first page, detect a second page, determine, based on a comparison of the first page with a plurality of stored formats, that the first page matches a first stored format of the plurality of stored formats, detect, using optical character recognition, a first field of the first page, determine, based on a comparison of the first field with a plurality of stored fields, that the first field matches a first stored field of the plurality of stored fields, extract, using optical character recognition, a first field value of the first field, and store, an association of the first field value to the first field, the first page, and the first document.

### TECHNICAL FIELD

The present application relates generally to systems and methods for implementing optical character recognition on two or more files.

### BACKGROUND

Optical character recognition (OCR) can recognize and extract text from images, documents, and other non-textual formats. OCR can convert the extracted text into machine-readable text data which can be used for a variety of purposes. Some purposes can include determining tax information.

### SUMMARY

One implementation is directed towards a system including one or more processors coupled to memory to receive a compressed file that is compressed using a data compression technique, split the compressed file into a plurality of documents including a first document, detect a first page of the first document, determine, based on a comparison of the first page with a plurality of stored formats, that the first page matches a first stored format of the stored formats, detect, using optical character recognition, a first field of the first page in response to the first page matching the first stored format, determine, based on a comparison of the first field with a plurality of stored fields, that the first field matches a first stored field of the stored fields, extract, using optical character recognition, a first field value of the first field in response to the first field matching the first stored field, and store, in the memory, an association of the first field value to the first field, the first page, and the first document.

In some implementations, the compressed file is a zip file. In some implementations, the one or more processors are further configured to detect, using optical character recognition, in response to detecting the first page using optical character recognition and before comparing the first page to the stored formats, a document type of the first page and the first stored format has the document type. In some implementations, the one or more processors are further configured to generate, using a first machine learning model, a text summary of the first page in response to extracting the first field value, the text summary being generated based on the document type and the first field value. In some implementations, the one or more processors are further configured to detect, using optical character recognition, in response to detecting the document type, a format type of the first page where the format type of the first page matches a format type of the first stored format.

In some implementations, the one or more processors are further configured to detect, using optical character recognition, in response to detecting the document type, a format type of the first page where the first page has the format type. In some implementations, the one or more processors are further configured to receive, at least one of an intellectual property identifier in response to extracting the first field value, generate, by a second machine learning model, a credit eligibility value based on the intellectual property identifier, the credit eligibility value generated by determining an owner of the intellectual property identifier, and store, the credit eligibility value where the intellectual property identifier includes at least one of a patent name, patent number, copyright name, copyright number, copyright symbol, trademark name, trademark number or trademark symbol. In some implementations, the one or more processors are further configured to detect a second page of a second document using optical character recognition where the plurality of documents include the second document, determine, based on a comparison of the first field with a second field of the second page, that the first field and the second field are equal, extract, using optical character recognition, a second field value of the second field in response to the first field and the second field being equal, determine, based on a comparison of the first field value and the second field value of the second field, that the first field value and the second field value are different, mark, the first field in response to the first field value and the second field value being different, and store, a marked first field.

In some implementations, the second page of the second document is stored in response to the second page not matching one of the plurality of stored formats. In some implementations, the one or more processors are further configured to detect, using the optical character recognition, a second field of the first page in response to detecting the first field, determine, based on a comparison of the second field to the plurality of stored fields, that the second field does not match one of the plurality of stored fields, record a second field count value in response to the second field not matching one of the plurality of stored fields, receive, a third document, add to the second field count value in response to detecting, by the optical character recognition, the second field on a page of the third document, and add the second field to the stored fields in response to the second field count value exceeding a field count value threshold.

Another implementation is directed towards a method. The method can include receiving, by one or more processors, a compressed file that is compressed using a data compression technique, splitting, by the one or more processors, the compressed file into a plurality of documents comprising a first document, detecting, by the one or more processors, a first page of the first document, determining, by the one or more processors, based on a comparison of the first page with a plurality of stored formats, that the first page matches a first stored format of the formats, detecting, by the one or more processors, using optical character recognition, a first field of the first page in response to the first page matching the first stored format, determining, by the one or more processors, based on a comparison of the first field with a plurality of stored fields, that the first field matches a first stored field of the stored fields, extracting, by the one or more processors, using optical character recognition, a first field value of the first field in response to the first field matching the first stored field, and storing, by the one or more processors, an association of the first field value to the first field, the first page, and the first document.

In some implementations, the compressed file is a zip file. In some implementations, the method further includes detecting, by the one or more processors, using optical character recognition, in response to detecting the first page using optical character recognition and before comparing the first page to the stored formats, a document type of the first page where the first stored format has the document type. In some implementations, the method further includes detecting, by the one or more processors, using optical character recognition, in response to detecting the document type, a format type of the first page where the first stored format has the format type. In some implementations, the method further includes receiving, by the one or more processors, at least one of an intellectual property identifier in response to extracting the first field value, generating, by the one or more processors, by a second machine learning model, a credit eligibility value based on the intellectual property identifier, the credit eligibility value generated by determining an owner of the intellectual property identifier, and storing, by the one or more processors, the credit eligibility value where the intellectual property identifier includes at least one of a patent name, patent number, copyright name, copyright number, copyright symbol, trademark name, trademark number or trademark symbol.

In some implementations, the method further includes detecting, by the one or more processors, a second page of a second document using optical character recognition where the plurality of documents comprise the second document, determining, by the one or more processors, based on a comparison of the first field with a second field of the second page, that the first field and the second field are equal, extracting, by the one or more processors, using optical character recognition, a second field value of the second field in response to the first field and the second field being equal, determining, by the one or more processors, based on a comparison of the first field value and the second field value of the second field, that the first field value and the second field value are different, marking, by the one or more processors, the first field in response to the first field value and the second field value being different, and storing, by the one or more processors, a marked first field. In some implementations, the second page of the second document is stored in response to the second page not matching one of the stored formats.

Another implementation is directed towards a non-transitory computer-readable medium having computer-executable instructions embodied therein that, when executed by at least one processor of a computing system, cause the computing system to perform operations including receiving a compressed file that is compressed using a data compression technique, splitting the compressed file into a first document and a second document, detecting a first page of the first document, detecting a second page of the second document using optical character recognition, determining, based on a comparison of the first page with a plurality of stored formats, that the first page matches a first stored format of the plurality of stored formats, detecting, using optical character recognition, a first field of the first page in response to the first page matching the first stored format, determining, based on a comparison of the first field with a plurality of stored fields, that the first field matches a first stored field of the plurality of stored fields, extracting, using optical character recognition, a first field value of the first field in response to the first field matching the first stored field, determining, based on a comparison of the first field with a second field of the second page, that the first field and the second field are equal, extracting, using optical character recognition, a second field value of the second field in response to the first field and the second field being equal, determining, based on a comparison of the first field value and the second field value of the second field, that the first field value and the second field value are different, marking the first field in response to the first field value and the second field value being different, storing a marked first field and store an association of the first field value to the first field, the first page, and the first document.

In some implementations, the compressed file is a zip file. In some implementations, the second page of the second document is stored in response to the second page not matching one of the stored formats. In some implementations, the operations further include detecting, using optical character recognition, in response to detecting the first page using optical character recognition and before comparing the first page to the stored formats, a document type of the first page and detecting, using optical character recognition, in response to detecting the document type, a format type of the first page where the first stored format has the format type.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is an illustrative example of a system for performing OCR across multiple documents, in accordance with one or more embodiments;

FIG. 2 is an illustrative example of a document for the system of FIG. 1 to perform OCR on, in accordance with one or more embodiments;

FIG. 3 illustrates an example implementation of a user interface depicting fields and field values of at least one document, in accordance with one or more embodiments;

FIG. 4 illustrates an example implementation of a user interface depicting fields and field values of at least one document, in accordance with one or more embodiments;

FIG. 5 illustrates an example implementation of a user interface depicting fields and field values of at least one document, in accordance with one or more embodiments;

FIG. 6 illustrates an example implementation of a user interface depicting fields and field values of at least one document, in accordance with one or more embodiments;

FIG. 7 illustrates an example implementation of a user interface depicting fields and field values of at least one document, in accordance with one or more embodiments;

FIG. 8 is an illustrative example of a method for performing OCR across multiple documents; and

FIG. 9 illustrates a block diagram of an example computing system for implementing the implementations of the present solution, including, for example, the system depicted in FIGS. 1-2, the method depicted in FIG. 8, and the graphical user interface depicted in FIGS. 2-7.

It will be recognized that the Figures are the schematic representations for purposes of illustration. The Figures are provided for the purpose of illustrating one or more implementations with the explicit understanding that the Figures will not be used to limit the scope of the meaning of the claims.

### DETAILED DESCRIPTION

Following below are more detailed descriptions of various concepts related to, and implementations of, methods, apparatuses, and systems for performing OCR on two or more files. The various concepts introduced above and discussed in greater detail below may be implemented in any of a number of ways, as the described concepts are not limited to any particular manner of implementation. Examples of specific implementations and applications are provided primarily for illustrative purposes.

OCR can be used in a variety of scenarios to read and extract information in non-textual formats, such as portable document format documents (PDFs). OCR recognizes and analyzes letters, numbers, and symbols and converts the non-textual formats into machine-readable data. The machine-readable data can then be used for a variety of purposes, such as extracting and storing field values. However, conventional OCR systems may require a user to upload individual documents. Additionally, conventional systems may not be able to compare information across documents. Specifically for tax purposes, it can be useful for a user to be able to upload compressed files to be able to visualize tax information the user may need to input into their tax documents and identify information that may be incorrect.

Implementations described herein relate to a system that receives a compressed file and splits the compressed file into one or more documents. The system can then use an OCR model to identify pages within the documents and compare the pages to a plurality of stored formats. The OCR model can be trained on the plurality of stored formats to detect pages that match the plurality of stored formats. Fields within the page can then be detected responsive to at least one of the pages matching a stored format. The fields can then be compared with a plurality of stored fields. The OCR model can be trained on the plurality of stored fields to identify the stored fields on the pages. Responsive to at least one of the fields matching a stored field, the value of the field is extracted and stored in association with the field, page, and the document. The system can determine whether pages within a document are eligible for the OCR model to perform OCR on as well as whether the fields on the page are relevant to the OCR model. For example, the OCR model may be trained on a plurality of tax document formats and tax-related fields. Responsive to none of the pages within the documents matching either the tax document formats or the tax-related fields, the system may not extract the field value and store the documents within a memory coupled to one or more processors of the systems.

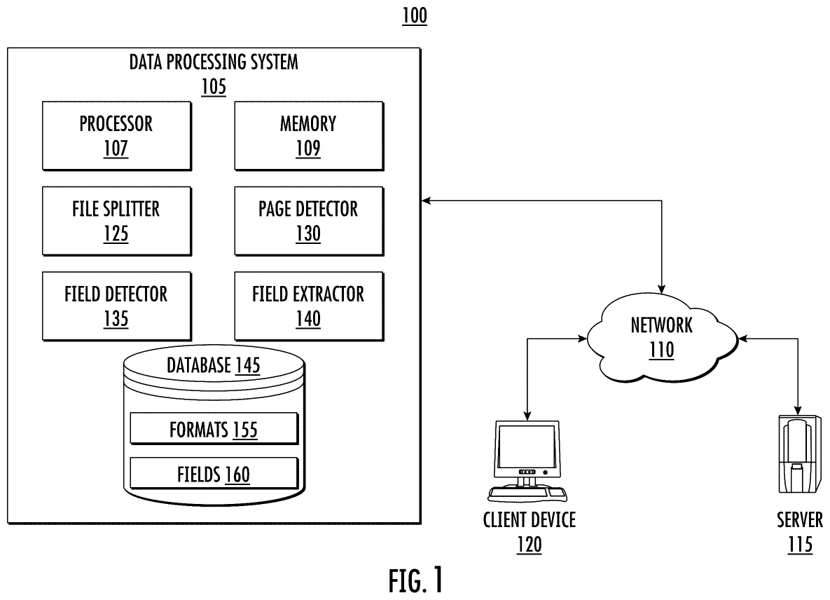

FIG. 1 is an illustrative example system 100 for performing OCR on multiple documents. The system 100 can include at least one data processing system 105, at least one network 110, and one or more client devices 120. Each of the components (e.g., the data processing system 105, the network 110, the client devices 120, etc.) of the system 100 can be implemented using the hardware components or a combination of software with the hardware components of a computing system, such as a server 115. The data processing system 105 can include at least one file splitter 125, at least one page detector 130, at least one field detector 135, at least one field extractor 140, and at least one database 145.

The data processing system 105 can include at least one processor 107 and a memory 109 (e.g., a processing circuit). The memory 109 can store processor-executable instructions that, when executed by processor 107, cause the processor to perform one or more of the operations described herein. The processor 107 can include a microprocessor, an application-specific integrated circuit (ASIC), a field-programmable gate array (FPGA), etc., or combinations thereof. The memory 109 can include, but is not limited to, electronic, optical, magnetic, or any other storage or transmission device capable of providing the processor 107 with program instructions. The memory 109 can further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor 107 can read instructions. The instructions can include code from any suitable computer programming language. The data processing system 105 can include one or more computing devices or servers that can perform various functions as described herein. The data processing system 105 can include any or all of the components and perform any or all of the functions of the server 115.

The network 110 can include computer networks such as the Internet, local, wide, metro or other area networks, intranets, satellite networks, other computer networks such as voice or data mobile phone communication networks, and combinations thereof. The data processing system 105 can communicate via the network 110, for example with one or more client devices 120. The network 110 can be any form of computer network that can relay information between the data processing system 105, the one or more client devices 120, and one or more information sources, such as web servers or external databases/storage devices, amongst others. In some implementations, the network 110 can include the Internet and/or other types of data networks, such as a local area network (LAN), a wide area network (WAN), a cellular network, a satellite network, or other types of data networks. The network 110 can also include any number of computing devices (e.g., computers, servers, routers, network switches, etc.) that are configured to receive and/or transmit data within the network 110.

Each of the client devices 120 can include at least one processor (e.g., similar to the processor 107) and a memory (e.g. similar to the memory 109). The memory can store processor-executable instructions that, when executed by processor, cause the processor to perform one or more of the operations described herein. The processor can include a microprocessor, an ASIC, an FPGA, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language. The client devices 120 can include one or more computing devices or servers that can perform various functions as described herein. The one or more client devices 120 can include any or all of the components and perform any or all of the functions described herein.

Each client device 120 can be, but is not limited to, a mobile device (e.g., a smartphone, tablet, etc.), a television device (e.g., smart television, set-top box, etc.), a personal computing device (e.g., a desktop, a laptop, etc.) or another type of computing device. Each client device 120 can be implemented using hardware or a combination of software and hardware. Each client device 120 can include a display or display portion. The display can include a display portion of a television, a display portion of a computing device, or another type of interactive display (e.g., a touchscreen, a display, etc.) and one or more input/output (I/O) devices (e.g., a mouse, a keyboard, digital keypad, etc.). The display can include a touch screen displaying an application. The display can include a border region (e.g., side border, top border, bottom border, etc.).

The application can include a web application, a server application, a resource, a desktop, or a file. In some implementations, the application can include a local application (e.g., local to a client device 120), hosted application, Software as a Service (SaaS) application, virtual application, mobile application, and other forms of content. In some implementations, the application can include or correspond to applications provided by remote servers or third-party servers.

Each of the client devices 120 can be computing devices configured to communicate via the network 110 to access information resources, such as web pages via a web browser, or application resources via a native application executing on a client device 120. When accessing information resources, the client device 120 can execute instructions (e.g., embedded in the native applications, in the information resources, etc.) that cause the client devices 120 to display application interfaces.

The server 115 can be a specialized computer or software that houses application programs and manages program data. Additionally, the server 115 can provide resources, including details related to functions such as payroll processing, employee recruitment, and personnel management, among others. More than one of the server 115 can be utilized to store data, facilitate applications, and offer services to clients. The server 115 can include OCR models and can perform OCR on information provided by the data processing system 105.

In some implementations, the data processing system 105 can include a database 145. The database 145 can be accessed using one or more memory addresses, index values, or identifiers of any item, structure, or region maintained in the database 145. The database 145 can be accessed by the components of the data processing system 105, or any other computing device described herein. In some implementations, the database 145 can be internal to the data processing system 105. In some implementations, the database 145 can exist external to the data processing system 105 and can be accessed via the network 110.

The database 145 can include a plurality of stored formats 155. The stored formats 155 can include different formats for various documents. For example, the stored formats 155 can include 10 different formats for W-2 documents. The database 145 includes an association of each of the stored formats 155 with a document type. The document type can refer to a type of tac, business, or personal document, among others. For example, the document type can include W-2, W-4, 1099 series, 1040 series, or W-9, among others. Each of the stored formats 155 can also be associated with a format type. The format type is different for each of the stored formats 155. For example, a first format type may have a title of the document at a first location while a second format type has the title in a second location, the first location different than the second location. Examples of the stored formats are shown below in Table 1.

TABLE 1
Examples of the Stored Formats

| Stored | Document | |
|---|---|---|
| Format | Type | Format Type |
| 1 | W-2 | Traditional W-2 layout |
| 2 | W-2 | Condensed 2up copy B/2 |
| 3 | 1040 | Schedule C |

The database 145 can also include a plurality of stored fields 160. The stored fields 160 can correspond to the stored formats 155. For example, each of the stored formats 155 can have a stored field 160 associated with the stored format 155. The stored fields 160 can include fields present on the format of the document type. In some implementations, the stored fields 160 can include all the fields present on each format type per document type. The stored fields 160 can also include fields of business impact (e.g., relevant fields). The fields of business impact can be determined based on at least one of business or government information. For example, the data processing system 105 can receive a plurality of documents relating to business and government information. Based on the plurality of documents, the data processing system 105 can determine the stored fields 160. For example, federal income withheld may be included in the stored fields 160 while a company name may not be included in the stored fields 160. The data processing system 105 may include a machine learning model to determine the stored fields 160. The machine learning model can be a supervised, unsupervised, semi-supervised, reinforcement, and/or ensemble learning model to determine the stored fields 160. Examples of the stored fields are shown below in Table 2.

TABLE 2
Examples of the Stored Fields

| Stored | Document | | |
|---|---|---|---|
| Format | Type | Format Type | Stored Fields |
| 1 | W-2 | Traditional | Federal Income |
| | | W-2 layout | Tax Withheld |
| 2 | W-2 | Condensed | Wages, Tips, other |
| | | 2up copy B/2 | Compensation |
| 3 | 1040 | Schedule C | Cost of Goods Sold |

In some implementations, the data processing system 105 can store, in one or more regions of the memory of the data processing system 105, or in the database 145, the results of any or all computations, determinations, selections, identifications, generations, constructions, or calculations in one or more data structures indexed or identified with appropriate values. Any or all values stored in the database 145 can be accessed by any computing device described herein, such as the data processing system 105, to perform any of the functionalities or functions described herein. In implementations where the database 145 forms a part of a cloud computing system, the database 145 can be a distributed storage medium in a cloud computing system and can be accessed by any of the components of the data processing system 105, by one or more client devices 120, or by any other computing devices described herein.

The data processing system 105 can include a file splitter 125, which can be a module, script, library, or function. The file splitter 125 can receive compressed files from the client device 120. The compressed file can be compressed using a data compression technique. The data compression techniques can include lossless (e.g., run-length encoding, arithmetic coding, etc.), lossy (e.g., transform coding, discrete wavelet transform, quantization, etc.), or compression algorithms (e.g., zip, RAR, PNG, etc.). The compressed file can be a zip file.

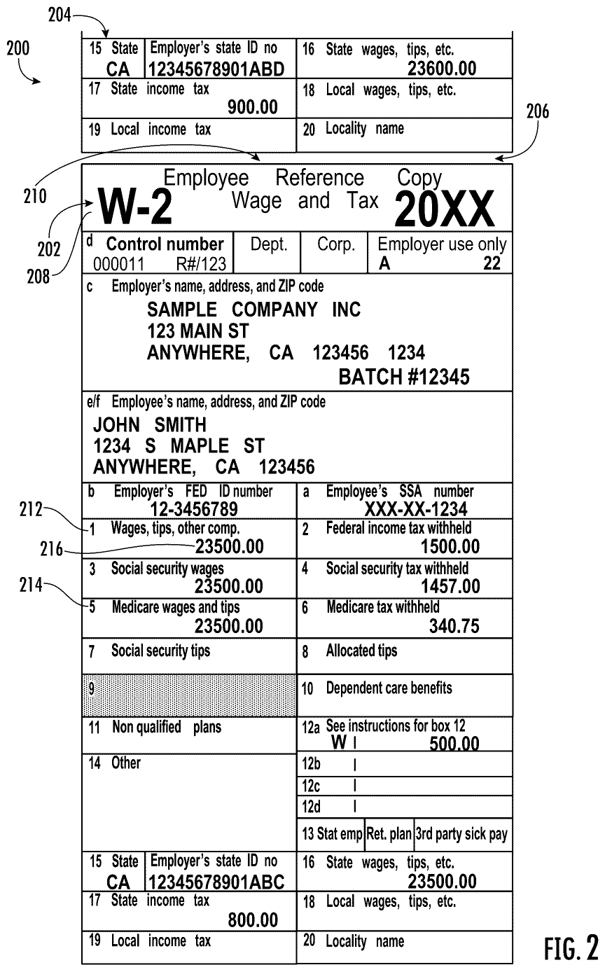

Upon receiving the compressed file, the file splitter 125 can split the compressed file into one or more documents. FIG. 2 depicts a first document 200. For example, the file splitter 125 can split the compressed file into a plurality of documents including a first document 200 and a second document. The file splitter 125 can reverse compression of the compressed file by using the compression algorithm used to compress the file. For example, the file splitter 125 can identify a compression format (e.g., zip) and use a decompression algorithm associated with the compression format to reverse the compression on the compressed file to receive the one or more documents (e.g., the first document 200).

The data processing system 105 can include a page detector 130, which can be a module, script, library, or function. The page detector 130 can receive the one or more documents from the file splitter 125. The page detector 130 can use an OCR model to detect pages within the one or more documents and split the one or more documents into one or more pages. For example, the page detector 130 can detect layouts of the pages within the one or more documents, and separate each of the pages based on empty space. The page detector 130 can detect regions on a first page containing text and regions on a second page containing text. Based on a distance between the regions, the page detector 130 can separate and/or classify the pages as a first page and a second page. The page detector 130 can separate the pages on each of the one or more documents simultaneously and/or in parallel. For example, the page detector 130 can detect a first page on a first document and a second page on a second document. As another example, given the document 200, the page detector 130 can detect a first page 202 and a second page 204 and separate the first page 202 and the second page 204 based on empty space 206. The page detector 130 can include a first OCR model to detect pages. The first OCR model can convert pages and documents into digital text files for further analysis (e.g., field extraction).

Responsive to the page detector 130 not detecting pages within the one or more documents, the page detector 130 may use the first OCR model to detect pages up to 3 times. Responsive to the page detector 130 not detecting pages on the third time, the page detector 130 can store the document in the database 145.

The page detector 130 can compare pages (e.g., the first page 202) within the one or more documents with the stored formats 155. For example, in response to detecting a first page 202 of the first document 200, the page detector 130 can detect a document type 208 of the first page 202. The page detector 130 can determine the document type 208 from the first page 202. For example, the page detector 130 can detect the first page 202 and then detect a document type 208 by scanning the first page 202. The first OCR model can be trained on the stored formats 155. The first OCR model can be trained to recognize documents matching at least one of the stored formats 155. The page detector 130 can store pages detected within the document in the database 145.

The page detector 130 may compare the document type 208 of the first page 202 with the document types of the stored formats 155. Responsive to the document type 208 matching a document type of a stored format 155 of the stored formats 155, the page detector 130 can detect a format type 210 of the first page 202 using the first OCR model. The first OCR model can detect the format of the first page 202 and determine the format type 210. The first OCR model can process various elements of the format (e.g., lines, boxes, text, etc.) of the first page to determine the format type 210. The page detector 130 can then compare the format type 210 of the first page 202 to the format types in the stored formats 155. Responsive to the format type 210 of the first page 202 matching at least one of the format types of the stored formats 155, the page detector 130 can determine that the first page 202 is eligible for field detection. The page detector 130 can store results of the detection in the database 145. For example, the page detector 130 can store the document type 208 and the format type 210 of the first page 202 in the database 145.

Based on the document type 208 and the format type 210, the page detector 130 can generate a configuration file. The page (e.g., the first page 202) can include a plurality of fields and a plurality of field values. The configuration file can determine which fields and field values are to be extracted from the pages. For example, responsive to the page detector 130 determining that the first page 202 is a W-2 document type (e.g., the document type 208), the page detector 130 can generate the configuration file to include a plurality of fields 212 including federal income tax withheld, social security wages, social security tips, allocated tips, dependent care benefits, etc. and a corresponding plurality of field values 216. The page detector 130 can use information stored in the database 145 associated with the document type 208 to generate the configuration file. The configuration file can also indicate the format type 210 of the page. The format type 210 can include information regarding fields 212 on the format type 210, and locations of the fields 212 on the page for the format type 210. For example, the format type 210 can indicate that the first page 202 includes federal income tax withheld as well as the location of the field 212 and the corresponding field value 216 location on the first page 202. The data processing system 105 can use the configuration file to extract values 216 based on the document type 208 and the format type 210.

In response to the pages of the one or more documents not matching the document type and the format type of the stored formats 155, the one or more documents can be stored in the database 145. In some implementations, the first page 202 of the first document 200 matches the stored formats 155 while a second page 204 of the first document 200 does not match. In this case, the second page 204 is stored in the database 145 while the first page 202 is further processed by the data processing system 105.

In some implementations, the page detector 130 can receive a plurality of documents as an input and add to the stored formats 155 based on format types 210 of the plurality of documents. For example, as the page detector 130 receives more documents, the page detector 130 can be continuously trained to recognize and add format types 210 to the stored formats 155. For example, the page detector 130 can include a format type threshold. The page detector 130 can include a first format value, and add to the first format value responsive to detecting the first format type 210. Responsive to the first format value satisfying the format threshold, the first format type 210 can be added to the stored formats 155.

In some implementations, responsive to the one or more documents not matching the document type 208 and the format type 210, the page detector 130 can perform post-processing actions (e.g., OCR post-page actions). For example, the page detector 130 can spell check, label fields, normalize data, or classify the documents 200, among others. Following the post-processing actions, the page detector 130 can store the one or more documents in the database 145. The page detector 130 can also notify the user via the client device 120 that the one or more documents did not match the document type 208 and the format type 210.

In some implementations, the page detector 130 may detect and determine that the pages (e.g., the second page 204) of the document 200 are ineligible for OCR. For example, the page detector 130 may detect a quality of the page. The page detector 130 can detect a resolution, distortion, or noise, among others of the page. Responsive to the quality of the page being below a quality threshold of the page detector 130, the page detector 130 can store the page. In some implementations, the page detector 130 can perform pre-processing actions on the page (e.g., prior to applying an OCR model). The page detector 130 can binarize, deskew, denoise, or sharpen, among others the page. The page detector 130 can then detect the quality of the page again. Responsive to determining that the quality of the page is above the quality threshold, the page detector 130 can detect a document type 208 of the page. Responsive to determining that the quality of the page remains below the quality threshold, the page detector 130 can store the page in the database 145.

The data processing system 105 can include a field detector 135, which can be a module, script, library, or function. Responsive to determining that at least one page (e.g., the page 202) of the one or more documents (e.g., the document 200) matches a stored format 155 of the stored formats 155, the field detector 135 can receive the pages and the configuration file from the page detector 130. For example, responsive to determining that the first page 202 of the first document 200 matches a first stored format 155 of the stored formats 155, the field detector 135 can receive the first page 202 and detect a first field 212 (e.g., object) of the first page 202.

Responsive to the field detector 135 not detecting a field 212 on the pages (e.g., the first page 202), the field detector 135 may attempt to detect the field up to 3 times. Responsive to the field detector 135 not detecting a field on a third try, the field detector 135 can store the pages in the database 145.

The field detector 135 can use an OCR model to detect fields 212 within a page (e.g., the first page 202). The field detector 135 can include a second OCR model. The second OCR model can be trained on the stored fields 160. The second OCR model can compare fields 212 detected on the page with the stored fields 160. The second OCR model can also use the configuration file to detect the fields 212. For example, the field detector 135 can receive the format type 210 from the page detector 130. The field detector 135 can then detect the fields 212 based on the format type 210 of the page received from the configuration file. The location of the fields 212 can differ per format type 210 of the document type 208. The second OCR model can detect characters of the fields 212 on the page and compare the characters to the stored fields 160. In some implementations, the field detector 135 can associate each of the fields 212 detected by category. For example, the second OCR model can be trained to classify each field 212 according to a category. The categories may include company, tax, or personal details, among others. The field detector 135 can store each of the fields 212 detected along with the association in the database 145.

In some implementations, the field detector 135 can receive a plurality of documents as an input and add fields 212 to the stored fields 160. As such, the field detector 135 can learn relevant fields 212 (e.g., to add to the stored fields 160) over time. For example, the field detector 135 can detect a second field 214 of the first page 202 in response to detecting the first field 212. The field detector 135 can also determine, based on a comparison of the second field 214 to the stored fields 160, that the second field 214 does not match one of the stored fields 160. The field detector 135 can then record a second field count value in the database 145 response to the second field 214 not matching one of the stored fields 160. The second field count value can indicate a number of times that the field detector 135 has detected a field not stored within the stored fields 160. The field detector 135 can then receive another document (e.g., a third document). The field detector 135 can perform field detection using the second OCR model on pages of the third document. Responsive to the field detector 135 detecting the second field 214 on a page of the third document, the field detector 135 can add to the second field count value in the database 145. The field detector 135 can continue adding to the second field count value responsive to detecting the second field 214 in pages of documents received. Responsive to determining that the second field count value exceeds a field count value threshold, the second field 214 can be added to the stored fields 160. The field count value threshold can be determined by the second OCR model and can be dependent on the stored fields 160. For example, the field count value threshold can be based on a number of documents that the stored fields 160 can be detected in.

The data processing system 105 can include a field extractor 140, which can be a module, script, library, or function. Responsive to determining that at least one of the fields matches one of the stored fields 160, the field extractor 140 can receive at least one page (e.g., the first page 202) from the field detector 135 and the configuration file. For example, responsive to determining that the first field 212 of the first page 202 matches a first stored field 160 of the stored fields 160, the field detector 135 provides the first page 202 to the field extractor 140. The field extractor 140 can also include the second OCR model. The field extractor 140 can extract a first field value 216 of the first field 212 using the second OCR model. For example, the second OCR model can detect and extract the fields 212 based on the format type 210 of the page (e.g., the first page 202) as indicated by the configuration file. The format type 210 may indicate a location of the field value 216 on the page. The configuration file can also include the stored fields 160. For example, the field extractor 140 can extract values for the federal income tax withheld and social security wages responsive to determining that the configuration file includes these fields 212. The second OCR model can use the configuration file to extract values 216 on the page. Once extracted, the field extractor 140 can store the field values 216 in the database 145. The field extractor 140 can store the field values 216 in the database 145 along with a corresponding file, document (e.g., the document 200), document type 208, and/or format type 210.

Responsive to determining that none of the fields matches one of the stored fields 160, the field detector 135 can store the detected fields along with the page and the document in the database 145. For example, the field detector 135 stores the fields 212 along with the first page 202 and the document 200 in the database 145. The field detector 135 can perform post-processing actions on the page and the document prior to storing the page and the document in the database 145.

In some implementations, the second OCR model can extract values near the field names on the page or generate bounding boxes to extract the field values. The field extractor 140 can also detect missing field values. For example, responsive to determining that the first field does not have a corresponding first field value, the field extractor 140 can mark the first field and store an indication that the first field value is missing. The first field value may be missing due to a failure of, for example, the user to input a value for the first field and/or data of the field may be unclear to the second OCR model. For example, the first field value may be below the quality threshold. In some implementations, the page is above the quality threshold while fields or field values of the page are below the quality threshold. In this case, the second OCR model marks the first field value as missing.

In some implementations, the field extractor 140 can include a first machine learning model. The first machine learning model can be a generative artificial intelligence (AI) model. For example, the field extractor 140 can generate a text summary of the first page 202 in response to extracting the first field value 216. The field extractor 140 can generate text summaries for each page that the field extractor 140 extracts field values from. The text summary can be generated based on both the document type 208 of the first page 202 and the first field value 216. The text summary can provide, for example, users a brief overview of contents of the document or missing field values, among others. The field extractor 140 may generate the text summary in a format based on the document type 208. For example, responsive to determining that the document type is W-2, the text summary can be “clients are paying taxes.” The text summary can appear on the user interface for users to view.

In some implementations, responsive to extracting the field value (e.g., the first field value 216), the field extractor 140 can also extract at least one of an intellectual property identifier from the page (e.g., the page 202). The intellectual property identifier can include at least one of a patent name, patent number, copyright name, copyright number, copyright symbol, trademark name, trademark number, or trademark symbol. The intellectual property identifier can be associated with a field identified in the format type 210. Responsive to receiving the intellectual property identifier, the field extractor 140 can determine eligibility for research and development (R&D) credit. For example, in some countries such as India, companies and/or individuals can be eligible for tax credits based on R&D which can be evidenced by intellectual property rights that the company and/or individual holds or is pursuing. Eligibility for the R&D credit can be based on ownership of the intellectual property rights. In this case, the field extractor 140 can include a second machine learning model. The second machine learning model can be an AI model. The second machine learning model can be a natural language processing (NLP) model. The second machine learning model can be trained (e.g., with supervised learning) on a plurality of intellectual property documents to identify owners of the intellectual property. The second machine learning model can be connected to a database of intellectual property documents. The field extractor 140 can determine an owner to the rights of the intellectual property based on the intellectual property identifier using the second machine learning model.

For example, responsive to detecting a patent number, the field extractor 140 can input the patent number into the second machine learning model. The second machine learning model can then extract a patent document based on the patent number, and determine the owner of the patent number from the patent document and/or from the patent number (e.g., by contacting a third party database, providing the patent number, and receiving the owner). For example, the second machine learning model can read text of the patent document to determine a patent owner to determine eligibility for R&D credit. In some embodiments, the field extractor 140 includes a third OCR model to determine the owner. For example, based on the intellectual property identifier, the field extractor 140, using the second machine learning model, can find and extract a document associated with the intellectual property identifier. The document can then be fed to the third OCR model to detect the owner on the document. In some embodiments, the owner is not stated on the document. In this case, the field extractor 140 can use the second machine learning model to search, for example, a database to determine the owner of the intellectual property identifier to determine R&D credit eligibility.

Following the identification of the owner to the rights of the intellectual property, the field extractor 140 can generate a credit eligibility value based on the intellectual property identifier. The credit eligibility value can be zero or greater than zero. For example, responsive to determining that a name of either an individual or a company on the page does not match the name of the owner of the intellectual property identifier, the credit eligibility value is zero. Responsive to determining that the name matches the name of the owner, the credit eligibility value can be positive, indicating that, for example, a user is eligible for the R&D credit. In some implementations, the field extractor 140 can generate the credit eligibility value based on an amount of credit the user may be eligible for. This can be based on extracted field values or by requesting the user to provide further inputs, such as the total amount spent on R&D for the intellectual property associated with the intellectual property identifier. The field extractor 140 can then store the credit eligibility value in the database 145.

In some implementations, the field extractor 140 can determine a level of confidence of the extracted field values. For example, the field extractor 140 can compare field values of matching fields and determine that the field values are different. The field extractor 140 can then mark the field for the user. The field extractor 140 can determine that the first field 212 and a second field on a second page (e.g., the second page 204) are equal using the second OCR model. The field extractor 140 can then extract a second field value of the second field in response to the first field and the second field being equal. The field extractor 140 can then compare the second field value and the first field value and determine that the second field value and the first field value are different. Responsive to determining that the second field value and the first field value are different, the field extractor 140 can mark the first field 212. Marking the first field 212 can indicate low confidence (e.g., uncertainty) in the extracted field values 216 of the first field 212. The first field 212 being marked can also indicate to the user that there may be discrepancies or inaccuracies within the pages of the document. The field extractor 140 can then store the first field 212 as a marked first field 212 in the database 145. The marked first field 212 can be stored in association with its corresponding first page 202 and first document 200 in the database 145.

Following extraction of the field values by the field extractor 140, post-processing actions can be performed on the page (e.g., the first page 202). The data processing system 105 can also indicate to the user that results of the field extractor 140 are ready for review. Following post-processing actions of the page, the page can be stored in the database 145. The field extractor 140 can also store an association of the field value to the field, the page, and the document in the memory 109 and/or the database 145. For example, the field extractor 140 can store an association off the first field value 216 to the first field 212, the first page 202, and the first document 200. For example, the field extractor 140 can store a first association with each of the first field value 216, the first field 212, the first page 202, and the first document 200. As another example, the field extractor 140 can index the first field value 216 with the first field 212, the first page 202, and the first document 200.

The data processing system 105 can then use the association to highlight the first field value 216 on the first page 202 of the first document 200 on the client device 120 responsive to the user selecting to view the first field value 216. The data processing system 105 can also store details of the documents such as document metadata (e.g., file type, format, date created, etc.).

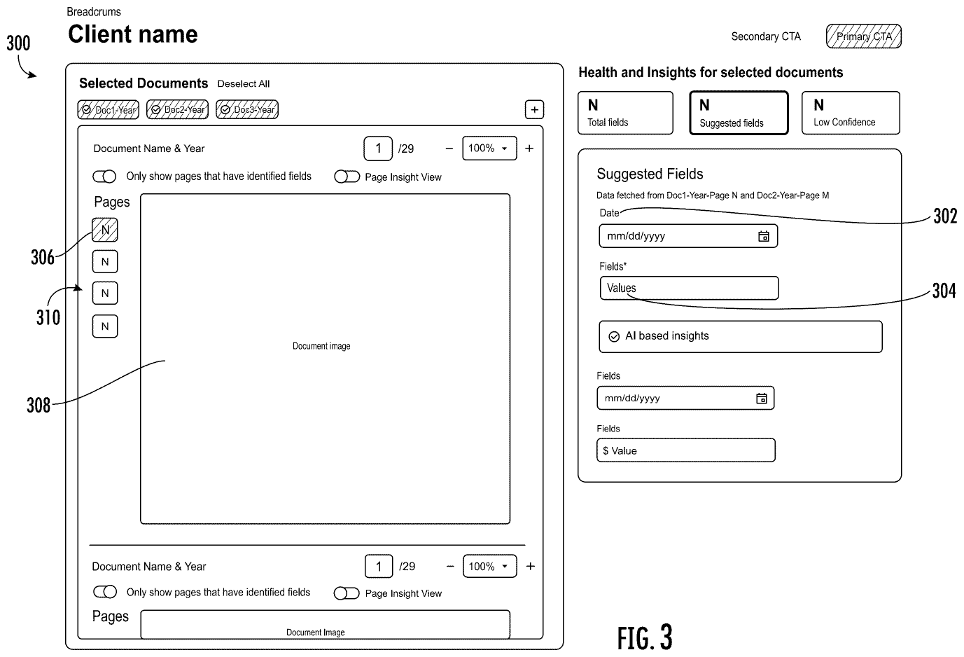

FIGS. 3-7 illustrate results of performing OCR on multiple documents, as described in connection with FIG. 1. As shown in FIG. 3, the data processing system 105 can generate a user interface 300 to display on the client device 120. The data processing system 105 can extract information (e.g., field values) from the database 145 to display on the user interface 300. For example, the user interface 300 includes fields 302 and corresponding field values 304. The fields 302 and the field values 304 are extracted from a page 306 of the documents 308 as shown on the user interface 300. In some implementations, the user interface 300 can present several fields 302 the users can select through to provide direct input or for the users to view. The user interface 300 can include the text summary generated by the field extractor 140 and display the one or more documents 308 and the one or more pages 306 as associated in the database 145. The user interface 300 can also display suggested fields 302 which can correspond to the stored fields 160 or to fields with missing field values. For example, the user can input values for the fields 302 with missing field values 304 via the user interface 300. The user interface 300 can also provide UI elements 310 for the users to interact with to view specific pages of documents.

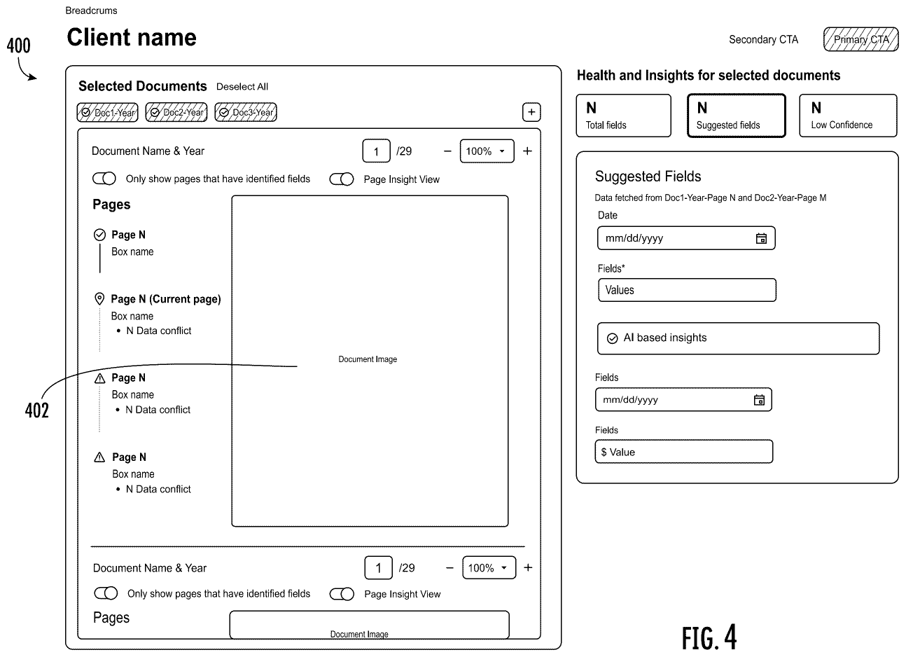

As shown in FIG. 4, the user interface 400 can also display details per page of the one or more documents 402. The user interface 400 can display pages where discrepancies may be present based on the level of confidence. For example, responsive to determining that the page includes the marked field, the user interface 400 can indicate which pages include marked fields for the users to review. The marked fields may be displayed to the user as low confidence as seen in the user interface 400.

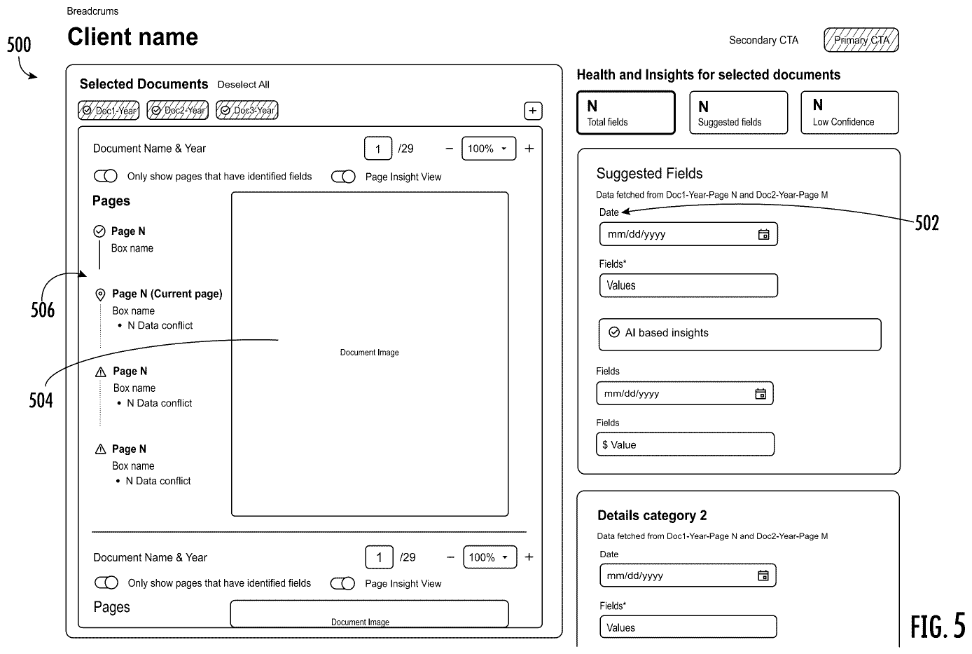

As shown in FIG. 5, the user interface 500 can display total fields 502 of the one or more documents 504 and the one or more pages 506. The total fields 502 can correspond to the stored fields 160 or can be a total number of fields detected by the field detector 135. The total fields 502 can include fields matching the stored fields 160 and fields not matching the stored fields 160. The total fields 502 can be separated by category as marked by the field detector 135. Each of the documents 504 displayed via the user interface 500 can include total fields 502. In some implementations, the user interface 500 includes suggested fields and low confidence fields. For example, responsive to determining that none of the fields of selected documents are marked, the user interface 500 does not include low confidence fields.

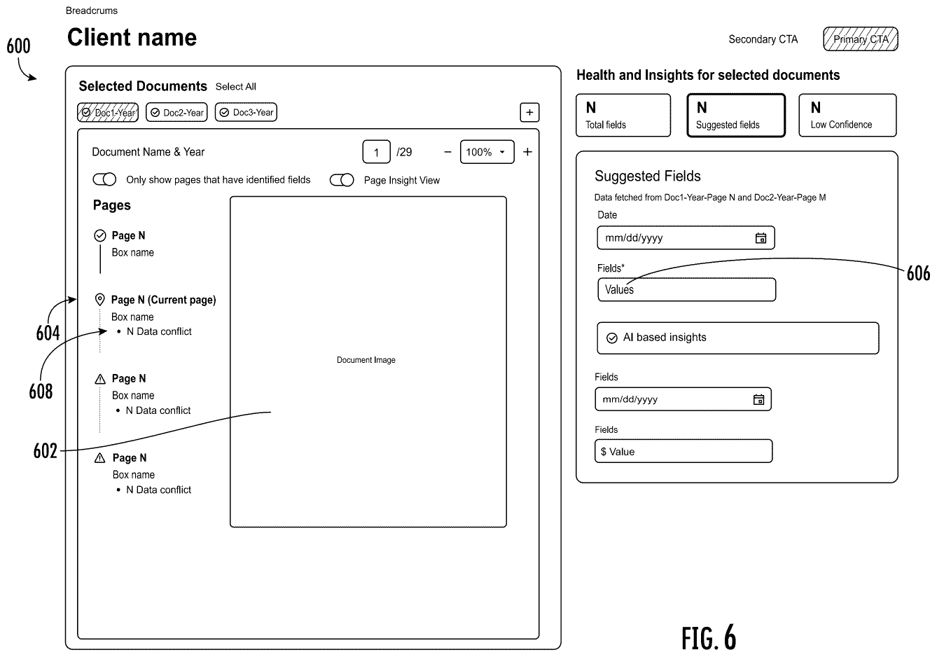

As shown in FIG. 6, the user interface 600 can display one document 602 of the one or more documents. While reviewing the results, the users can select to view the pages 604 of the one document 602 of the one or more documents. The user interface 600 can then display field values 606 and page details 608 corresponding to the one document. The user interface 600 may highlight the field values 606 and page details 608 corresponding to the one document 602 based on an association of the field values 606 and page details 608 to the one document.

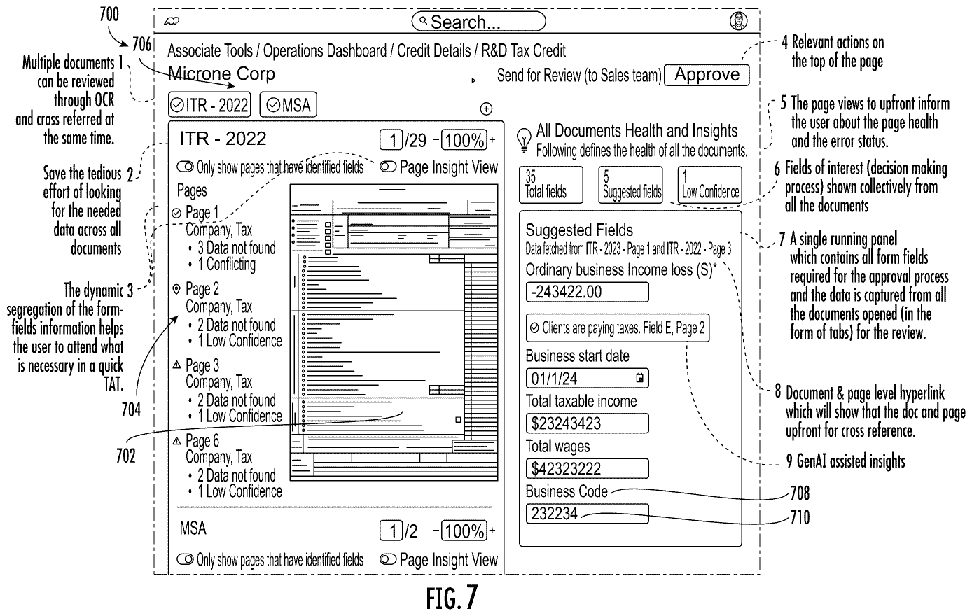

As shown in FIG. 7, the user interface 700 can include one or more documents 702 and one or more pages 704 corresponding to the one or more documents 702. The user interface 700 can include UI elements 706 to select and view pages 704 with identified fields 708. The user interface 700 can also separate the fields 708 based on low confidence and suggested fields. The low confidence fields can be the marked fields. Total fields can include the low confidence and the suggested fields. The user interface 700 can indicate which page 704 of which document 702 each of the fields 708 and corresponding field values 710 were extracted from based on the associations of the field value 710 in the database 145. The data processing system 105 can highlight fields 708 on the document 702 based on the user interacting with UI elements 706 of the user interface 700. For example, responsive to the user interacting with a field 708 on the user interface 700, the data processing system 105 highlights a corresponding field value 710 on the document based on the association stored in the database 145. The highlight may be a different color than a background color of the user interface 700. For example, responsive to determining that the background color of the user interface 700 is white, the highlight is yellow.

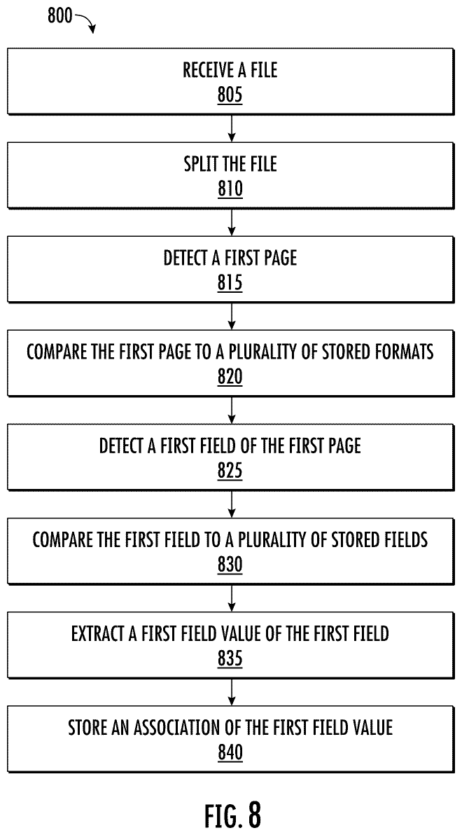

FIG. 8 is an example method 800 for processing files and extracting field values. The method 800 can be performed by one or more processors (e.g., the processor 107). The method 800 can be performed by one or more systems or components depicted in FIG. 1. The method 800 can include one or more processors receiving a file (805). The file can be a compressed file. The method 800 can include one or more processors splitting the file (810). The first file may be split into a plurality of documents including a first document. The method 800 can include one or more processors detecting a first page (815). The first page can be detected on the first document. The method 800 can include one or more processors comparing the first page to a stored format (820). Responsive to determining that the first page does not match a first stored format of the stored formats, the first page can be stored. The method 800 can include one or more processors detecting a first field of the first page (825). The method 800 can include one or more processors comparing the first field to a stored fields (830). The method 800 can include one or more processors extracting a first field value of the first field (835). The method 800 can include one or more processors storing an association of the first field value with the first field (840). The one or more processors can also store an association of the first field value with the first field, the first page, and the first document.

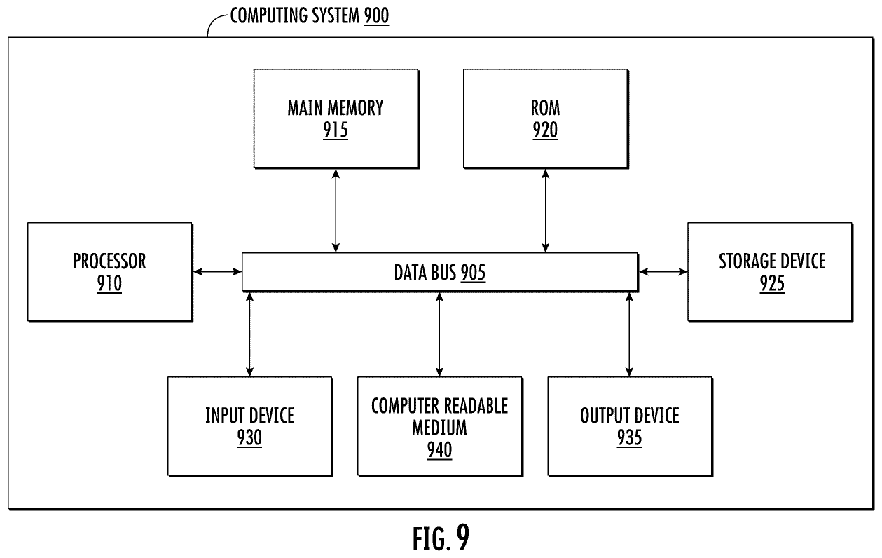

FIG. 9 illustrates a block diagram of a computing system 900 for implementing the implementations of the technical solutions discussed herein, in accordance with various aspects. FIG. 9 illustrates a block diagram of an example computing system 900, which can also be referred to as the computer system 900. Computing system 900 can be used to implement elements of the systems and methods described and illustrated herein. Computing system 900 can be included in and run any device (e.g., a server, a computer, a cloud computing environment, or a data processing system).

Computing system 900 can include at least one bus data bus 905 or other communication device, structure, or component for communicating information or data. Computing system 900 can include at least one processor 910 or processing circuit coupled to the data bus 905 for executing instructions or processing data or information. Computing system 900 can include one or more processors 910 or processing circuits coupled to the data bus 905 for exchanging or processing data or information along with other computing systems 900. For example, the one or more processors 910 are configured to receive a compressed file and use an OCR model to detect and extract the first field value of the first field of a first page of a first document. Computing system 900 can include one or more main memories 915, such as a random access memory (RAM), dynamic RAM (DRAM), cache memory or other dynamic storage device, which can be coupled to the data bus 905 for storing information, data and instructions to be executed by the processor(s) 910. Main memory 915 can be used for storing information (e.g., data, computer code, commands, or instructions) during execution of instructions by the processor(s) 910. For example, the main memory 915 can store instructions for the processor 910 to split the compressed file into a plurality of documents including a first document and a second document.

Computing system 900 can include one or more read only memories (ROMs) 920 or other static storage device 925 coupled to the data bus 905 for storing static information and instructions for the processor(s) 910. Storage devices 925 can include any storage device, such as a solid state device, magnetic disk or optical disk, which can be coupled to the data bus 905 to persistently store information and instructions.

Computing system 900 can include at least one computer readable medium 940 (e.g., non-transitory computer readable medium). The computer readable medium 940 may be a tangible computer readable medium storage storing computer readable program code (e.g., computer-executable instructions) for execution by the, for example, the processor 910 and/or the processor 107. The computer readable storage medium may be, for example, but not limited to, an electronic, magnetic, optical, electromagnetic, infrared, holographic, micromechanical, or semiconductor system, apparatus, or device, or any suitable combination of the foregoing. For example, the computer readable medium 940 can store computer-executable instructions for the processor 107 to determine that a first field value and a second field value are different responsive to determining that the first field and the second field are equal.

Computing system 900 can be coupled via the data bus 905 to one or more output devices 935, such as speakers or displays (e.g., liquid crystal display or active matrix display) for displaying or providing information to a user. The output devices 935 can display, for example, the user interface 300, the user interface 400, the user interface 500, the user interface 600, and the user interface 700. Input devices 930, such as keyboards, touch screens or voice interfaces, can be coupled to the data bus 905 for communicating information and commands to the processor(s) 910. Input device 930 can include, for example, a touch screen display (e.g., output device 935). Input device 930 can include a cursor control, such as a mouse, a trackball, or cursor direction keys, for communicating direction information and command selections to the processor(s) 910 for controlling cursor movement on a display. The input device 930 can enable a user to interact with the user interface 300, the user interface 400, the user interface 500, the user interface 600, and the user interface 700. User interaction may cause the computing system 900 to highlight portions of the user interface 300, the user interface 400, the user interface 500, the user interface 600, and the user interface 700.

The processes, systems and methods described herein can be implemented by the computing system 900 in response to the processor 910 executing an arrangement of instructions contained in main memory 915. Such instructions can be read into main memory 915 from another computer-readable medium, such as the storage device 925. Execution of the arrangement of instructions contained in main memory 915 causes the computing system 900 to perform the illustrative processes described herein. One or more processors 910 in a multi-processing arrangement can also be employed to execute the instructions contained in main memory 915. Hard-wired circuitry can be used in place of or in combination with software instructions together with the systems and methods described herein. Systems and methods described herein are not limited to any specific combination of hardware circuitry and software.

Although an example computing system has been described in FIG. 9, the subject matter including the operations described in this specification can be implemented in other types of digital electronic circuitry, or in computer software, firmware, or hardware, including the structures disclosed in this specification and their structural equivalents, or in combinations of one or more of them.

The foregoing examples have been provided merely for the purpose of explanation and are in no way to be construed as limiting of the present disclosure. While aspects of the present disclosure have been described with reference to an exemplary implementation, it is understood that the words which have been used herein are words of description and illustration, rather than words of limitation. Changes can be made, within the purview of the appended claims, as presently stated and as amended, without departing from the scope and spirit of the present disclosure in its aspects. Although aspects of the present disclosure have been described herein with reference to particular means, materials and implementations, the present disclosure is not intended to be limited to the particulars disclosed herein; rather, the present disclosure extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs (e.g., one or more circuits of computer program instructions, encoded on one or more computer storage media for execution by, or to control the operation of, data processing apparatuses). Alternatively, or in addition, the program instructions can be encoded on an artificially generated propagated signal (e.g., a machine-generated electrical, optical, or electromagnetic signal) that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry (e.g., an FPGA (field programmable gate array) or an ASIC (application specific integrated circuit)). The apparatus can also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry (e.g., an FPGA (field programmable gate array) or an ASIC (application specific integrated circuit)). Devices suitable for storing computer program instructions and data can include non-volatile memory, media and memory devices, including by way of example semiconductor memory devices (e.g., EPROM, EEPROM, and flash memory devices; magnetic disks, e.g., internal hard disks or removable disks; magneto optical disks; and CD-ROM and DVD-ROM disks). The processor and the memory can be supplemented by, or incorporated in, special purpose logic circuitry.

The subject matter described herein can be implemented in a computing system that includes a back end component (e.g., as a data server, or that includes a middleware component, an application server, or that includes a front end component, a client computer having a graphical user interface or a web browser through which a user can interact with an implementation of the subject matter described in this specification, or a combination of one or more such back end, middleware, or front end components). The components of the system can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts, and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

What is claimed is:

1. A system comprising:
one or more processors, coupled with memory, the one or more processors configured to:
receive a compressed file that is compressed using a data compression technique;
split the compressed file into a plurality of documents comprising a first document;
detect a first page of the first document;
determine, based on a comparison of the first page with a plurality of stored formats, that the first page matches a first stored format of the stored formats;
detect, using optical character recognition, a first field of the first page in response to the first page matching the first stored format;
determine, based on a comparison of the first field with a plurality of stored fields, that the first field matches a first stored field of the stored fields;
extract, using optical character recognition, a first field value of the first field in response to the first field matching the first stored field; and
store, in the memory, an association of the first field value to the first field, the first page, and the first document.

2. The system of claim 1, wherein the compressed file is a zip file.

3. The system of claim 1, wherein:
the one or more processors are further configured to detect, using optical character recognition, in response to detecting the first page using optical character recognition and before comparing the first page to the stored formats, a document type of the first page; and
the first stored format has the document type.

4. The system of claim 3, wherein the one or more processors are further configured to:
generate, using a first machine learning model, a text summary of the first page in response to extracting the first field value, the text summary being generated based on the document type and the first field value.

5. The system of claim 3, wherein:
the one or more processors are further configured to detect, using optical character recognition, in response to detecting the document type, a format type of the first page; and
the first stored format has the format type.

6. The system of claim 3, wherein:
the one or more processors are further configured to:
receive, at least one of an intellectual property identifier in response to extracting the first field value;
generate, by a second machine learning model, a credit eligibility value based on the intellectual property identifier, the credit eligibility value generated by determining an owner of the intellectual property identifier; and
store, the credit eligibility value;
the intellectual property identifier comprises at least one of a patent name, patent number, copyright name, copyright number, copyright symbol, trademark name, trademark number or trademark symbol.

7. The system of claim 1, wherein the one or more processors are further configured to and the plurality of documents comprise a second document:
detect a second page of the second document using optical character recognition;
determine, based on a comparison of the first field with a second field of the second page, that the first field and the second field are equal;
extract, using optical character recognition, a second field value of the second field in response to the first field and the second field being equal;
determine, based on a comparison of the first field value and the second field value of the second field, that the first field value and the second field value are different;
mark, the first field in response to the first field value and the second field value being different; and
store, a marked first field.

8. The system of claim 7, wherein the second page of the second document is stored in response to the second page not matching one of the stored formats.

9. The system of claim 1, wherein the one or more processors are further configured to:
detect, using the optical character recognition, a second field of the first page in response to detecting the first field;
determine, based on a comparison of the second field to the stored fields, that the second field does not match one of the stored fields;
record a second field count value in response to the second field not matching one of the stored fields;
receive, a third document;
add to the second field count value in response to detecting, by the optical character recognition, the second field on a page of the third document; and
add the second field to the stored fields in response to the second field count value exceeding a field count value threshold.

10. A method comprising:
receiving, by one or more processors, a compressed file that is compressed using a data compression technique;
splitting, by the one or more processors, the compressed file into a plurality of documents comprising a first document;
detecting, by the one or more processors, a first page of the first document;
determining, by the one or more processors, based on a comparison of the first page with a plurality of stored formats, that the first page matches a first stored format of the stored formats;
detecting, by the one or more processors, using optical character recognition, a first field of the first page in response to the first page matching the first stored format;
determining, by the one or more processors, based on a comparison of the first field with a plurality of stored fields, that the first field matches a first stored field of the stored fields;
extracting, by the one or more processors, using optical character recognition, a first field value of the first field in response to the first field matching the first stored field; and
storing, by the one or more processors, an association of the first field value to the first field, the first page, and the first document.

11. The method of claim 10, wherein the compressed file is a zip file.

12. The method of claim 10, further comprising:
detecting, by the one or more processors, using optical character recognition, in response to detecting the first page using optical character recognition and before comparing the first page to the stored formats, a document type of the first page;
wherein the first stored format has the document type.

13. The method of claim 12, further comprising:
detecting, by the one or more processors, using optical character recognition, in response to detecting the document type, a format type of the first page;
wherein the first stored format has the format type.

14. The method of claim 10, further comprising:
receiving, by the one or more processors, at least one of an intellectual property identifier in response to extracting the first field value;
generating, by the one or more processors, by a second machine learning model, a credit eligibility value based on the intellectual property identifier, the credit eligibility value generated by determining an owner of the intellectual property identifier; and
storing, by the one or more processors, the credit eligibility value;
wherein the intellectual property identifier comprises at least one of a patent name, patent number, copyright name, copyright number, copyright symbol, trademark name, trademark number or trademark symbol.

15. The method of claim 10, wherein the plurality of documents comprise a second document, the method further comprising:
detecting, by the one or more processors, a second page of the second document using optical character recognition;
determining, by the one or more processors, based on a comparison of the first field with a second field of the second page, that the first field and the second field are equal;
extracting, by the one or more processors, using optical character recognition, a second field value of the second field in response to the first field and the second field being equal;
determining, by the one or more processors, based on a comparison of the first field value and the second field value of the second field, that the first field value and the second field value are different;
marking, by the one or more processors, the first field in response to the first field value and the second field value being different; and
storing, by the one or more processors, a marked first field.

16. The method of claim 15, wherein the second page of the second document is stored in response to the second page not matching one of the stored formats.

17. A non-transitory computer-readable medium having computer-executable instructions embodied therein that, when executed by at least one processor of a computing system, cause the computing system to perform operations comprising:
receiving a compressed file that is compressed using a data compression technique;
splitting the compressed file into:
a first document, and
a second document;
detecting a first page of the first document;
detecting a second page of the second document using optical character recognition;
determining, based on a comparison of the first page with a plurality of stored formats, that the first page matches a first stored format of the stored formats;
detecting, using optical character recognition, a first field of the first page in response to the first page matching the first stored format;
determining, based on a comparison of the first field with a plurality of stored fields, that the first field matches a first stored field of the stored fields;
extracting, using optical character recognition, a first field value of the first field in response to the first field matching the first stored field;
determining, based on a comparison of the first field with a second field of the second page, that the first field and the second field are equal;
extracting, using optical character recognition, a second field value of the second field in response to the first field and the second field being equal;
determining, based on a comparison of the first field value and the second field value of the second field, that the first field value and the second field value are different;
marking the first field in response to the first field value and the second field value being different;
storing a marked first field; and
storing an association of the first field value to the first field, the first page, and the first document.

18. The non-transitory computer-readable medium of claim 17, wherein the compressed file is a zip file.

19. The non-transitory computer-readable medium of claim 17, wherein the second page of the second document is stored in response to the second page not matching one of the stored formats.

20. The non-transitory computer-readable medium of claim 17, the operations further comprising:
detecting, using optical character recognition, in response to detecting the first page using optical character recognition and before comparing the first page to the stored formats, a document type of the first page; and
detecting, using optical character recognition, in response to detecting the document type, a format type of the first page;
wherein the first stored format has the format type.
